(19) United States
(12) Patent Application Publication
(10) Pub. No.: US 2008/0051310 A1
(43) Pub. Date: Feb. 28, 2008

(54) Enzymes as Active Oxygen Generators in Cleaning Compositions

(75) Inventors: Mattia De Dominicis, Montvale, NJ (US); Lilana Oliva, Venice (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 11/572,117

(22) PCT Filed: Jul. 18, 2005
(86) PCT No.: PCT/GB05/02808

§ 371 Date: Mar. 23, 2007

(30) Foreign Application Priority Data
Jul. 16, 2004 (GB) 0415905.9

(51) Int. Cl. C11D 3/386

(52) U.S. Cl. 510/393

(57) ABSTRACT

The invention relates to liquid cleaning compositions that contain an oxidase enzyme which has a substrate within a stain.

The invention relates to liquid cleaning compositions that contain an oxidase enzyme.

Cleaning products supplied as liquids are often considered to be more convenient to use than are dry particulate cleaning products (e.g. powder or granulate products). Liquid cleaning compositions have therefore found substantial favour with consumers. Such cleaning products are readily measurable, speedily dissolved in the wash water, capable of being easily applied in concentrated solutions or dispersions to soiled areas on garments to be laundered and are non dusting. They also usually occupy less storage space than particulate products.

Additionally, cleaning compositions supplied as liquids may have incorporated in their formulations materials which could not withstand drying operations without deterioration, which operations are often employed in the manufacture of particulate cleaning products.

Cleaning products supplied as liquids in terms of their most basic components will generally essentially comprise functional ingredients such as one or more surface active agents (surfactants) that promote and facilitate the removal of stains and soils from fabrics laundered in aqueous wash solutions formed from such cleaning products.

Cleaning products supplied as liquids will also generally contain a liquid carrier such as water which serves to dissolve or at least suspend the essential functional surfactant ingredients. In addition to surfactants and a carrier liquid, such cleaning products can also contain a wide variety of additional functional ingredients which serve to boost the fabric cleaning effectiveness of the products into which they are incorporated, such as enzymes (for example protease or amylase).

Cleaning products supplied as liquids suffer one major drawback: due to the presence of water it is not easy to incorporate a bleaching agent. Hydrogen peroxide is highly unstable in such a complex mixture, especially in the presence of heavy metal ions. In addition it is highly unstable in the alkaline conditions preferred for laundry and fabric treatment cleaning compositions. Traditional peracids (such as percarbonate or perborate) are not stable in the presence of moisture.

Another important aspect is that the use of hydrogen peroxide or any other traditional bleaching agent in cleaning compositions supplied as liquids is not possible in the presence of enzymes. Proteases, amylases, lipases etc. are frequently present in such cleaning products for improving stain removal. Enzymes are generally incompatible with oxidising agents and tend to be degraded in the presence of active oxygen.

US20010044397A1—Bleaching Enzymes and Detergent Compositions comprising them—Unilever Home & Personal Care USA—describes the use of bleaching enzymes conjugated to antibodies that specifically bind to a chemical present in a stain, e.g. pectin. In addition the substrate for the bleaching enzyme is supplied separately to the enzyme; see Example 8.

U.S. Pat. No. 6,479,450B1—Bleaching System—Henkel—describes a bleaching system that can be used in laundry detergents that has an enzyme which produces hydrogen peroxide from atmospheric oxygen.

U.S. Pat. No. 5,288,746A1—Liquid Laundry Detergents Containing Stabilized Glucose/Glucose Oxidase as H₂O₂ Generation System—Procter & Gamble Company—describes a detergent composition containing glucose oxidase and glucose wherein the reaction is inhibited by the presence of Ca²⁺ or Ag⁺ ions until such ions are diluted in the mark.

We have surprisingly found that stained fabric can contain sufficient substrate for an oxidase enzyme present in the laundry detergent to generate sufficient quantities of hydrogen peroxide to produce a consumer distinguishable improvement in the removal of oxidisable stains on the fabric.

Therefore, we present as a feature of the invention, a cleaning composition comprising:

water;

and an oxidase enzyme;

characterised in that the composition is essentially free from any substrate of the oxidase enzyme.

The method we present, as an alternative feature, is a method of removing an oxidisable stain from a surface containing a substrate for an oxidase enzyme, the method comprising adding to the surface water and a cleaning composition comprising an oxidase enzyme characterised in that the cleaning composition is essentially free from any substrate of the oxidase enzyme.

In the method the oxidase enzyme may be delivered to the stain by, for example, spraying, spreading (e.g. with a roller device), or immersion.

Suitable substrate for the oxidase enzyme is a product found in a typical domestic stain on a soiled fabric. Domestic stains are those that are picked up on fabric worn in a home environment, such as spilt food. Stains include: food, blood, grass, drink (soft drinks, hot drinks, or alcoholic drinks). Specific substrates are selected from; lipids, polysaccharides, mono- or di-saccharides and proteins, especially, glucose, starch, pectin, albumin, albumen and C₁₄₋₂₀ saturated or mono unsaturated or poly unsaturated fatty acids.

In the alternative, the substrate for the oxidase enzyme may be added to the fabric prior to the washing method, for example, in the form of a stain pretreating composition. Ideally applied over a stain, preferably an oxidisable stain. Or the substrate may be added to the wash liquor as a second composition.

Preferably there is more than one different type of oxidase enzyme. Such a mixture will be able to deal with many different stain types.

Preferably the laundry cleaning composition is presented inside an air and liquid tight container, ideally on bottle with a cap. Ideally the bottle has only one chamber.

Oxidase Enzyme

Such enzymes can be effective even at low concentration, starting from 0.01 ppm of enzyme and 50 ppm of substrate. The enzymes are also compatible with liquid cleaning formulations and have a low impact on the overall formulation cost.

Suitable oxidase enzymes are those classified under enzyme classification E.C.1.1.3 (Acting on the CH—OH group of donors with oxygen as acceptor).

Preferred enzymes are selected from one or more of the following; Malate oxidase, Glucose oxidase, Hexose oxidase, Cholesterol oxidase, Galactose oxidase, Pyranose oxidase, oxidase, and Cellobiose oxidase and Nucleoxide oxidase; in each case preferably as such, i.e. preferably not coupled to another reagent or component.

Preferably the oxidase enzyme is:
1) not a conjugate protein, or
2) does not contain an epitope; or
3) contains less than 10% base pair modifications (ideally less than 8%, 6%, 4%, 2%, 1%, 0.5% 0.1%, 0.05%, 0.01% or 0.001%) compared with the wild type enzyme from which it is derived; or
4) the number of base pair modifications compared with the wild type enzyme from which it is derived is less than 100, 80, 60, 40, 20, 10 or 5.

Preferably at least two of such conditions 1)-4) apply; more preferably at least three; and most preferably all four.

A preferred enzyme is Glucose Oxidase. Glucose Oxidase is a highly specific enzyme derived from the fungi Aspergillus Niger and Penicillinum. Glucose oxidase is an oxidoreductase, that catalyses the oxidation of D-Glucose to gluconic acid using molecular oxygen and releasing hydrogen peroxide. Glucose oxidase has a molecular weight of 192000, an optimum temperature of 30-50° C. and optimum pH of 4.5-6.5, although higher pHs can be tolerated well by such enzymes. It is inhibited by heavy metal salts, preferably a chelating agent may be added to the composition, and sulphydil chelating agents. The effective enzyme amount needed is from 0.001% to 5%, more preferably between 0.01 and 1%.

The reaction is:
C₆H₁₂O₆+H₂O+O₂→C₆H₁₂O₇+H₂O₂(glucose oxidase) 1.

An important feature of the invention is that any substrate for the oxidase enzyme used is not present in the composition packaged. A preferred feature is that the substrate for the oxidase enzyme is one that is present in soiled fabrics, for examples, selected from one or more of the following, sugars, starch, lipids, etc. A preferred substrate is D-glucose, which is present in many foods or added as glucose syrup. Examples of stains containing glucose are jams, fruit juices, beverages and many different sauces, such as ketchup.

Other Enzymes

A preferred optional component of the compositions herein comprises cleaning enzyme material that contains one or more protease enzymes, one or more lipases and one or more amylase enzymes, one or more mannases, or a mixture of any thereof. Such an additional enzyme component will generally comprise from about 0.05% to 1.0% by weight of the compositions herein, more preferably from about 0.15% to 0.4% by weight of the compositions herein. Within this enzyme component, one or more protease enzyme materials will generally be present in an amount sufficient to provide from about 0.005 to 0.1 Anson units (AU) of protease activity per gram of composition.

Such enzymes can be selected from those that are sensitive to oxidative denaturation since the source of active oxygen (H₂O₂) is not produced until the oxidase enzyme meets its substrate on the stain or in the wash liquor.

Amylase enzyme materials will be present to the extent of from about 0.01% to 1.0% by weight of the composition.

Examples of suitable proteases are the subtilisins which are obtained from particular strains of B. subtilis and B. licheniforms. Such protease enzymes are described in greater detail in G13 1,243,784; EP 130,756A; EP 303,761A; WO 97/18140A; WO 93/03529A; WO 95/10591A; WO 95.07791; and WO 94/25583. All of these patent publications are incorporated herein by reference. Suitable protease materials are marketed under the tradenames Esperase (Novo), Alcalase (Novo), Savinase (Novo) and Maxatase (International Bio-Synthetics). Arnylases (cc and P) may be used for removal of carbohydrate-based stains. These amylase enzymes may be of any subtilisin origin such as vegetable, animal, bacterial, farigal or yeast origin. Amylase enzymes are described in greater detail in WO 95/26397A; G13 1,296,839; WO 94/02597A; WO 94/18314; and WO 95/09909A. Suitable amylase materials are marketed when the tradenames Termamyl (Novo), Fungamyl (Novo), BAN (Novo), Rapidase (International Bio-Synthetics) and Duramyl (Novo).

Other types of cleaning enzymes have also been widely employed in cleaning compositions. Such enzymes as include, cellulases and peroxidases, and are well known. It is possible to add one or more of these non-protease, non-amylase types of enzymes to the cleaning compositions herein to improve the effectiveness of the composition in removing certain types of soils/stains or improving the fabric.

Surfactant

Preferably a surfactant is present. Such compositions can contain a surfactant system that comprises from about 0.001% to 50% by weight of surfactants, preferably from 0.01 to 30% by weight. Suitable surfactants for this invention are anionic, non ionic, amphoteric and cationic surfactants, preferably anionic and non ionic surfactants are used.

Anionic surfactant suitable for this invention comprises ethoxylated alkyl sulfate surfactants. Such materials, known as alkyl ether sulfates or alkyl polyethoxylate sulfates, are those which correspond to the formula: R′—O—(C2H40)n-SO3M wherein R′ is a C8-C20 alkyl group, n is from about 1 to 20, and M is a salt-forming cation. Preferably, R′ is C10-C18 alkyl, n is from about 1 to 15, and M is sodium, potassium, ammonium; alkylammonium, or alkanolammonium. Most preferably, W is a C12-C16, n is from about 1 to 6 and M is sodium.

The alkyl ether sulfates will generally be used in the form of mixtures comprising varying R′ chain lengths and varying degrees of ethoxylation. Frequently such mixtures will inevitably also contain some unethoxylated alkyl sulfate materials, i.e., surfactants of the above ethoxylated alkyl sulfate formula wherein n═O.

One preferred type of optional anionic surfactant which may be used in the compositions herein comprises primary or secondary unethoxylated alkyl sulfate anionic surfactants. Such surfactants are those produced by the sulfation of higher C8-C20 alcohol. Conventional primary alkyl sulfate surfactants have the general formula: wherein R is typically a linear C8-C20 hydrocarbonyl group, which may be straight chain or branched chain, and M is a water-solubilising cation. Preferably R is a C10-C15 alkyl, and M is alkali metal. Most preferably R is C12-C14 and M is sodium.

Conventional secondary alkyl sulfates may also be. Conventional secondary alkyl sulfate surfactants are those materials which have the sulfate moiety distributed randomly along the hydrocarbyl “backbone” of the molecule. Such materials may be depicted by the structure: wherein m and n are integers of 2 or greater and the sum of m+n is typically about 9 to 15, and M is a water-solubilizing cation.

Especially preferred types of secondary alkyl sulfates are the (2, 3) alkyl sulfate surfactants which can be represented by structures of formulas A and B: for the 2-sulfate and 3-sulfate, respectively. In formulas A and B, x and (y+1) are, respectively, integers of at least about 6, and can range from about 7 to about 20, preferably about 10 to about 16. M is a cation, such as an alkali metal, alkaline earth metal, or the like. Sodium is typical for use as M to prepare the water-soluble (2, 3) alkyl sulfates, but potassium, and the like, can also be used.

Other optional anionic surfactants which may be employed, include in general the carboxylate-type anionies. Carboxylate-type anionics include fatty acid, e.g., C₁₀₋₁₈, soaps, the C₁₀₋₁₈ alkyl alkoxy carboxylates (especially the EO 1 to 5 ethoxycarboxylates) and the C₁₀₋₁₈ sarcosinates, especially oleoyl sarcosinate. One other common type of anionic surfactant which could be utilised in the compositions herein comprises the aromatic anionics, e.g., alkyl benzene sulfonates.

Ethoxylates and certain surfactant amines are suitable non ionic surfactants for this invention. These materials are described as follows:

i) Fatty Alcohol Ethoxylate nonionic surfactant materials useful herein are those of C₈₋₁₆ alkyl group from about 1 to 16 ethylene oxide moieties per molecule. Preferably the alkyl group, which may be primary or secondary, contains from about 9 to 15 carbon atoms, more preferably from about 10 to 14 carbon atoms. Preferably the ethoxylated fatty alcohols will contain from about 2 to 12 ethylene oxide moieties per molecule, more preferably from about 3 to 10 ethylene oxide moieties per molecule.

The ethoxylated fatty alcohol nonionic surfactant will frequently have a hydrophilic-lipophilic balance (HLB) which ranges from about 3 to 17. More preferably, the HLB of this material will range from about 6 to 15, most preferably from about 10 to 15.

Examples of fatty alcohol ethoxylates useful for this invention have been commercially marketed under the tradenames Neodol 25-7 and Neodol 23-6.5 by Shell Chemical Company, Other useful Neodols include Neodol 1-5, ethoxylated fatty alcohol averaging 11 carbon atoms in its alkyl chain with about 5 moles of ethylene oxide; Neodol 23-9, an ethoxylated primary C12-C13 alcohol having about 9 moles of ethylene oxide and Neodol 9 1-10, an ethoxylated C⁹—C¹¹ primary alcohol having about 10 moles of ethylene oxide. Alcohol ethoxylates of this type have also been marketed by Shell Chemical Company under the Dobanol tradename.

Dobanol 91-5 is an ethoxylated C⁹⁻¹¹ fatty alcohol with an average of 5 moles ethylene oxide and Dobanol 25-7 is an ethoxylated C¹²⁻¹⁵ fatty alcohol with an average of 7 moles of ethylene oxide per mole of fatty alcohol.

Other examples of suitable ethoxylated alcohol nonionic surfactants include Tergitol 15-S-7 and Tergitol 15-S-9, both of which are linear secondary alcohol ethoxylates that have been commercially marketed by Union Carbide Corporation. The former is a mixed ethoxylation product of C¹¹ to C¹⁵ linear secondary alkanol with 7 moles of ethylene oxide and the latter is a similar product but with 9 moles of ethylene oxide being reacted.

Other types of alcohol ethoxylate nonionics useful in the present compositions are higher molecular weight nonionics, such as Neodol 45-11, which are similar ethylene oxide condensation products of higher fatty alcohols, with the higher fatty alcohol being of 14-15 carbon atoms and the number of ethylene oxide groups per mole being about 11. Such products have also been commercially marketed by Shell Chemical Company.
ii) Other non-ionic surfactants useful for present invention are surfactant amines. Suitable surfactant amines for use herein include amines according to the formula: 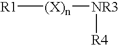
wherein R1 is a C6-C12 alkyl group; n is from about 2 to about 4, X is a bridging group which is selected from NH, CONH, COO, or O or X can be absent; and R3 and R4, which are each bonded directly to the nitrogen of the amine group, are individually selected from H, C1-C4 alkyl or CH2-CH2-0R5 wherein R5 is H or methyl. Preferred surfactant amines include wherein R1 is a C6-C12 alkyl group and R5 is H or CH3.

Particularly preferred surfactant amines include those selected from the group consisting of octyl amine, hexyl amine, decyl amine, dodecyl amines, C8-C12 N,N-bis-(hydroxyethyl)amine, C8-C12 N,N-bis(hydroxyisopropyl) amine, and C8-C16, preferably C8-C12, amido-propyl dimethyl amine, and mixtures of these amines.

iii) Other optional non ionic surfactant can be considered are, for example, C₁₀₋₁₈ alkyl polyglucosides when high foaming compositions are desired; polyhydroxy fatty acid amides, ethylene oxide-propylene oxide block polymers of the Pluronic type; and the like.

One of the most preferred types of optional nonionic surfactants comprises the polyhydroxy fatty acid amides. Such materials fully described in Pan/Gosselink; U.S. Pat. No. 5,332,528; Issued Jul. 26, 1994, incorporated herein by reference. These materials the general structure of the formula: wherein R1 is H, C1-C4 hydrocarbyl, 2-hydroxyethyl, 2-hydroxypropyl, or a mixture thereof, R2 is C5-C31 hydrocarbyl; and Z is a polyhydroxylhydrocarbyl having a linear hydrocarbyl chain with at least 3 hydroxyls directly connected to the chain, or an alkoxylated derivative thereof. Examples of such surfactants include the C10-CI8 Nmethyl, or N-hydroxypropyl, glucamides. The N-propyl through N-hexyl C12-C16 glucamides can be used for low sudsing performance.

Cationic and Amphoteric surfactants can also be used in addition to the anionic and nonionic surfactants here in before described. Examples of such materials include quaternary ammonium cationics, C10-C18 amine oxides and the C12-C18 betaines and sulfobetaines.

Water

The cleaning compositions herein comprises a liquid carrier, water. In a washing process water may be present in vast excess over the composition as added. When the composition is in the form of a liquid concentrate as supplied, generally the liquid carrier will comprise from about 50% to 95% by weight of the compositions herein. More preferably this liquid carrier component will comprise from about 70% to less than 90% by weight of the compositions herein. The most cost effective type of liquid carrier is, of course, water itself. Other types of water-miscible liquids can also be included and are selected from, alkanols, diols, other polyols, ethers, amines, glycols and glycol ether or mixtures of any thereof.

Optional Cleaning Composition Ingredients

The cleaning compositions of the present invention can also include any number of additional optional ingredients in an amount of up to 25% wt, 20% wt, 15% wt, 12% wt, 10% wt, 8% wt, 6% wt, 4% wt, 2% wt or 1% wt individually. These are selected from one or more of the following, thickeners, builders, suds boosters or suds suppressers, anti-tarnish and anticorrosion agents, soil suspending agents, soil release agents, germicides, pH adjusting agents, non-builder alkalinity sources, chelating agents, smectite clays, enzyme stabilisers (such as propylene glycol, calcium salts, boric acid and/or borax), hydrotropes, dye transfer inhibiting agents, optical brighteners and perfumes.

A few of the optional ingredients which can be used are described in greater detail as follows:

Cleaning Builders: The cleaning compositions herein may also optionally contain low levels of an organic cleaning builder material which serves to counteract the effects of calcium, or other ion, water hardness encountered during laundering bleaching use of the compositions herein. Examples of such materials include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids C10-C22 fatty acids and citric acid. Other examples are organic phosphonate type sequestering agents such as those which have been sold by Monsanto under the Dequest tradename and alkanehydroxy phosphonates. Citrate salts and C12-C18 fatty acid soaps are highly preferred. Other suitable organic builders include the higher molecular weight polymers and copolymers known to have builder properties. For example, such materials include appropriate polyacrylic acid, polymaleic acid, and polyacrylic/polymaleic acid copolymers and their salts, such as those sold by BASF under the Sokalan trademark.

Enzyme Stabilizers: The cleaning compositions herein may also optionally contain low levels of materials which serve to maintain the stability of the enzyme materials of the enzyme component. Such enzyme stabilizers can include, for example, polyols (such as propylene glycol), boric acid and borax. Combinations of these enzyme stabilizers may also be employed.

pH Control Agents: The cleaning compositions herein may also optionally contain low levels of materials which serve to adjust or maintain the pH of the aqueous cleaning compositions herein at optimum levels. The pH of the compositions of this invention which are to be used as pre-treaters or are to be added to water for a washing process should range from about 4 to 12, more preferably from about 7 to 11. Efficacy appears to be higher with alkaline compositions, preferably from about pH 8 to 11 (liquid compositions, as supplied). Materials such as NaOH can be added to alter composition pH, if necessary.

Perfumes may be added to the compositions herein for their conventional purpose, i.e. to improve the aesthetics of the products by providing a pleasant odour to the liquid products, both before and during use.

Product Formats

The cleaning composition may be applied in a ready-to-use concentration e.g. to be applied directly to a stain. Such a composition would then typically be left to work on the stain, prior to rinsing or washing. Such a composition may be poured from a bottle onto the stain, or may be applied to the stain by an applicator device, for example a trigger sprayer, an impregnated pad or wipe, or a roller device.

In another embodiment a liquid concentrate composition is supplied, forming on dilution the cleaning composition of the invention.

In another embodiment a particulate (e.g. granular or powder) or solid-form (e.g. tablet) composition may be supplied, forming on dilution a cleaning composition as defined above. A solid composition may contain a solid filler, for example sodium carbonate or sodium sulfate.

In embodiments in which a concentrate composition, whether liquid or solid, is supplied it may be used as a pre-treater, especially a pre-soaker, prior to a main wash; or it may be added to a main wash composition as a laundry booster.

The cleaning composition or a concentrate therefor may also be supplied as a gel.

It will be appreciated that a stain may be combated initially by digestion of a component of the stain which is a substrate for the complementary oxidase enzyme, and then by bleaching of other components of the stain by the active oxygen which forms as a result of the enzyme-substrate reaction.

### EXAMPLES

A known amount of D(+)-glucose is dissolved in water at ambient temperature or warmed at 40° C. The pH of solution is adjusted to the desired value by addition of sodium carbonate and then the selected amount of enzyme is dosed. Time zero is time of addition of the enzyme. Formation of H₂O₂ is detected by iodometric titration after 10 minutes and after 30 minutes (when necessary).

Glucose enzyme used: OxyGo HP L5000 (Genencor)

| Reaction | | Test Conditions | | | | |
|---|---|---|---|---|---|---|
| | H₂O₂ | | Water | Formulation | | |
| Time | developed | | tempera- | Enzyme | Glucose | Theoretical |
| (mins) | (%) | pH | ture | % | % | % of H₂O₂ |
| 10 | 0.03 | 9 | Ambient | 0.5 | 1.0 | 0.19 |
| 30 | 0.19 | 9 | Ambient | 0.5 | 1.0 | 0.19 |
| 10 | 0.32 | 9 | Ambient | 0.5 | 2.0 | 0.38 |
| 10 | 0.32 | 9 | 40° C. | 0.5 | 2.0 | 0.38 |
| 10 | 0.20 | 10.5 | Ambient | 1.0 | 4.0 | 0.76 |
| 30 | 0.40 | 10.5 | Ambient | 1.0 | 4.0 | 0.76 |
| 10 | 0.20 | 10.5 | 40° C. | 1.0 | 4.0 | 0.76 |
| 30 | 0.36 | 10.5 | 40° C. | 1.0 | 4.0 | 0.76 |

Reaction seems to be temperature independent
Reaction is faster at lower pH
At same pH, temperature and enzyme concentration, the reaction becomes faster increasing the amount of glucose (at pH=9, 1% of glucose is almost all transformed to H₂O₂ in 30 minutes, 2% of glucose takes around 10 minutes).
   Stain Removal Performance

Washing Conditions

| Washing: | pre-treatment of the stain (2 mL solution), | |
|---|---|---|
| | 30 minutes after application rinse under | |
| | tap water without rubbing | |
| Temperature: | Ambient | |
| Replications: | 3 | |
| Instrumental | Ultrascan XE Spectrophotometer | |
| evaluation: | (HunterLab) | |
| Visual Evaluation: | pictures | |
| Stains used: | blueberry juice - | (1.5 ml) |
| | blueberry jam - | (1 g) |
| | tea - | (0.5 ml) |
| | coffee - | (1 ml) |
| | red wine - | (1 ml) |

Formulations and Product Dosage

| | Enzyme (%) | pH |
|---|---|---|
| Formula 1 | 0.5 | 9 |
| Formula 2 | 1.0 | 9 |
| Formula 3 | 0 | 9 |
| Formula 4 | 0.5 | 10.5 |
| Formula 5 | 1.0 | 10.5 |
| Formula 6 | 0 | 10.5 |

Results—Instrumental

Pre-treatment results are compared with pure water at same pH of the enzymatic solution

| | | | | Blue- | |
|---|---|---|---|---|---|
| | | | | berry | Blueberry |
| | Tea | Coffee | Red wine | juice | jam |
| Formulations | ΔY-reflectance | | | | |
| ΔY | +0.1 | +6.3 | +2.9 | +9.1 | +14.1 |
| (formula 1-formula 3) | | | | | |
| ΔY | −0.7 | +3.1 | +4.7 | +10.1 | +9.6 |
| (formula 2-formula 3) | | | | | |
| ΔY | +0.6 | +1.2 | +11.0 | +6.6 | +3.0 |
| (formula 4-formula 6) | | | | | |
| ΔY | +8.8 | +11.8 | +11.3 | +33.8 | +19.5 |
| (formula 5-formula 6) | | | | | |

In all the four experiments enzymes were proven to be quite active, especially when 1% dosage is used.
When same enzyme dosage, at pH 10.5 stain removal is always better. This is true even if it was proven that at lower pH, speed of formation of H₂O₂ was always higher then at pH 10.5. What is apparently playing a crucial role is H₂O₂ activation with alkalinity.

1. A cleaning composition comprising;
water; and
an oxidase enzyme;
characterised in that the composition is essentially free from any substrate of the oxidase enzyme, and in that the oxidase enzyme is of a type which has a substrate comprised within a stain.

2. A cleaning composition according to claim 1 wherein the oxidase enzyme is glucose oxidase.

3. A cleaning composition according to claim 1 wherein more than one oxidase enzyme is present.

4. A cleaning composition in claim 1 wherein other enzymes are additionally present said other enzymes are selected from amylase, lipase, protease, mannanase or a mixture of any thereof.

5. A cleaning composition according to claim 1 wherein a surfactant is present in the composition.

6. A liquid pretreatment concentrate composition according to claim 1 adapted for the cleaning pretreatment of substrates prior, prior to their being washed.

7. A cleaning composition according to claim 1 wherein said cleaning composition is alkaline.

8. A particulate or solid-form composition forming on dilution with water a cleaning composition according to claim 1.

9. An air and liquid tight container containing a cleaning composition according to claim 1 within said air and liquid tight container.

10. A method of removing an oxidisable stain from a surface, the oxidisable stain containing a substrate for an oxidase enzyme, the method comprising the step of:
to said the surface, water and a cleaning composition comprising an oxidase enzyme characterised in that the cleaning composition is essentially free from any substrate of the oxidase enzyme.

11. A method of washing fabrics according to claim 10, wherein said surface is a fabric substrate.

12. A dilutable or dispersible concentrate cleaning composition according to claim 6 adapted for the cleaning of substrates prior to their being washed.

13. A dilutable or dispersible concentrate cleaning composition according to claim 6 wherein said resultant dilution of the cleaning concentrate composition is alkaline.

14. A particulate or solid-form composition forming on dilution with water a cleaning composition according to claim 6.

15. An air and liquid tight container containing a dilutable or dispersible cleaning composition according to claim 6 within said air and liquid tight container.
